(19) United States
(12) Patent Application Publication
(10) Pub. No.: US 2025/0283983 A1
(43) Pub. Date: Sep. 11, 2025

(54) DETECTOR ARRAY, CHIP, LIGHT RECEIVER, LIDAR, DETECTOR ARRAY CONTROL METHOD

(71) Applicant: HESAI TECHNOLOGY CO., LTD., Shanghai (CN)

(72) Inventors: Jie CHEN, CHEN (CN); Shaoqing XIANG, Shanghai (CN)

(73) Assignee: HESAI TECHNOLOGY CO., LTD., Shanghai (CN)

(21) Appl. No.: 19/219,708

(22) Filed: May 27, 2025

Related U.S. Application Data
(63) Continuation of application No. PCT/CN2023/134719, filed on Nov. 28, 2023.

(30) Foreign Application Priority Data
Nov. 28, 2022 (CN) 202211501296.6

(51) Int. Cl. G01S 7/4863; G01J 1/44; G01S 7/4914

(52) U.S. Cl. CPC G01S 7/4863; G01J 1/44; G01S 7/4914; G01J 2001/442; G01J 2001/4466; G01J 2001/448

(57) ABSTRACT

A detector array, a LiDAR, and a detector array control method are provided. The detector array includes: a plurality of detector units being divided into a plurality of detector unit groups; a plurality of anode buses, each of which connecting a plurality of detection units in a same detector unit group, and a number of the anode buses corresponding to a number of the detector unit groups; and a plurality of cathode buses, each of which connecting a plurality of detector units in at least two detector unit groups of the plurality of detector unit groups, and the plurality of detector units in a same detector unit group being connected to different cathode buses. A detector unit receives an optical signal when both its anode bus and cathode bus are activated, and converts the optical signal into an electrical signal for output.

### TECHNICAL FIELD

This disclosure relates to the field of circuit technologies, and in particular to a detector array, a chip, a light receiver, a LiDAR, and a detector array control method.

### BACKGROUND

A LIDAR is a measurement device that uses laser beams for object detection. The LiDAR can transmit a detection signal to an outside field of view and then compare the received echo signal with the transmitted detection signal to obtain one or more types of information (e.g., a position or a motion status of an object) to detect, track, position, or identify objects. In a LiDAR, a laser transmitting unit and a detection unit are arranged correspondingly. In the measurement data generated by the LiDAR, the data measured by one detection unit can generate a corresponding pixel in a point cloud. A multi-line LiDAR includes multiple detection units. Due to the existence of optical crosstalk and electrical crosstalk between detection units, the multiple detection units of the multi-line LiDAR are grouped and gated in sequence for measurement when detection is performed. The crosstalk (e.g., optical crosstalk or electrical crosstalk) between one or several detection units gated at the same time can become weak. Typically, each detection unit is generally provided with a control circuit (e.g., a pin connection control circuit) to meet the gating requirements.

For a high-resolution LiDAR, the detection units need to be arranged in a denser manner, so that more detection units can be arranged in the same space. The pins of the detection unit connected to the control circuit are welded to the circuit board through metal wires and then connected to the control circuit. In view of the existing processing technology, it is difficult to reduce the line spacing of the metal wires to less than 300 μm, thus limiting the density of arrangement of the detection units, which creates certain obstacles to the improvement of LiDAR resolution and cannot meet the application requirements of higher resolution.

### SUMMARY

On the one hand, embodiments of the present disclosure provide a detector array, a chip, a light receiver or a light receiver module, and a LiDAR, which can increase the number of detection units in a certain space while meeting the gating requirements, thereby effectively improving the resolution of the LiDAR.

On the other hand, embodiments of the present disclosure also provide a detector array control method, which can simply and conveniently control a detector array with a specific distribution structure.

In view of the above, the embodiments of the present disclosure provide the following technical solutions.

An embodiment of the present disclosure provides a detector array including: a plurality of detection-unit groups, each of the detection-unit groups including a plurality of detection units; a plurality of anode buses, each of the anode buses connecting the plurality of detection units in the same detection-unit group, and a number of the anode buses corresponding to a number of the detection-unit groups; and a plurality of cathode buses, each of the cathode buses connecting the detection units in at least two of the detection-unit groups, and the plurality of detection units in the same detection-unit group being respectively connected to different cathode buses; the detection unit can receive an optical signal when the anode bus and cathode bus to which it is connected are simultaneously gated, and convert the optical signal into an electrical signal for output.

Optionally, the detection unit is a single photon detector, and each detection unit corresponds to a pixel.

Optionally, the detection unit includes one or more detectors, and the detector is a silicon photomultiplier (“SiPM”) or a single-photon avalanche diode (“SPAD”).

Optionally, the detection unit is a back-side-illumination detection unit or a front-side-illumination detection unit.

Optionally, the detection units sharing one anode bus or one cathode bus are connected by a metal layer on a silicon wafer or are connected by wirings.

Optionally, the number of detection units sharing one cathode bus is less than or equal to 8.

Optionally, the detector array includes a first arrangement direction and a second arrangement direction, and any two detection units in the detector array are arranged staggered from each other in the first arrangement direction.

Embodiments of the present disclosure also provide a chip including the detector array described above.

Embodiments of the present disclosure also provide a light receiver module including a control unit and a detector array described above;
the control unit includes a plurality of anode driving circuits, a plurality of cathode driving circuits, an anode data multiplexer and a cathode data multiplexer, each of the anode driving circuits being connected to the anode data multiplexer and one of the anode buses, and each of the cathode driving circuits being connected to the cathode data multiplexer and one of the cathode buses;
the anode data multiplexer can gate the anode driving circuit based on a first trigger signal; and
the cathode data multiplexer can gate the cathode driving circuit based on a second trigger signal.

Optionally, the light receiver module further includes readout circuits that can collect an electrical signal output by the detection unit;
each of the cathode buses is respectively connected to one of the readout circuits; or,
each of the anode buses is respectively connected to one of the readout circuits.

Optionally, each of the cathode buses is connected to one of the readout circuits, the first trigger signal gates one of the anode driving circuits at a time, and the second trigger signal gates at least one of the cathode driving circuits at a time.

Optionally, each of the anode buses is respectively connected to one of the readout circuits, the first trigger signal gates at least one of the anode driving circuits at a time, and the second trigger signal gates one of the cathode driving circuits at a time.

Optionally, the readout circuit is connected to at least one of the detection units via the cathode bus or the anode bus, and greater the number of the detection unit connected to the readout circuit, the greater the gain set by the readout circuit.

Embodiments of the present disclosure also provide a LiDAR including a laser transmitting module and a light receiver module described above.

Embodiments of the present disclosure also provide a detector array control method to control the detection units in the detector array described above, including:
activating at least one of the detection units by bidirectionally addressing and gating the anode bus and the cathode bus;
receiving an optical signal and converting the optical signal into an electrical signal for output by the activated detection unit.

Optionally, the activating at least one of the detection units by bidirectionally addressing and gating the anode bus and the cathode bus including:
when the cathode bus is connected to the readout circuit, each time one anode bus and at least one cathode bus are gated, activating the detection unit, which is connected to both the gated anode bus and the gated cathode bus;
when the anode bus is connected to the readout circuit, each time at least one anode bus and one cathode bus are gated, activating the detection unit, which is connected to both the gated anode bus and the gated cathode bus.

The detector array, chip, light receiver module, and detector array control method provided by the embodiments of the present disclosure divide the detection units into multiple groups, each group includes multiple detection units, each anode bus connects the multiple detection units in the same group, each cathode bus connects detection units in at least two groups, and each detection unit in the same group can be connected to a different cathode bus. For example, multiple detection units can be divided into N groups, each group contains M detection units, forming a detector array containing N×M detection units. N anode buses and M cathode buses can be provided. The anodes of M detection units in the same group can be connected to the same anode bus, and each cathode bus can be connected to the cathode of one detection unit within each group. With the detection array described in the present disclosure, the only detection unit can be gated by selecting an anode bus and a cathode bus. The detection unit can be gated by selecting the anode bus and the cathode bus. Since the interconnected detection units (e.g., connected to the same anode bus or the same cathode bus) can share the same driving, thus greatly reducing the number of driving channels and the number of pads. For example, while the number of detectors remains unchanged, the number of metal wires that need to be connected can be greatly reduced. Thus, the detection units can be arranged more densely. While maintaining a certain line spacing and ensuring the performance of the detection units, more detection units can be accommodated in the same space. This also means that more lines of the LiDAR can be achieved within the same field of view to meet the requirements of higher resolution application.

### BRIEF DESCRIPTION OF THE DRAWINGS

To explain the embodiments of the present disclosure more clearly, the drawings to be used in association with the description of the embodiments are briefly introduced below. The drawings in the following description are only embodiments of the present disclosure. For those of ordinary skill in the art, other drawings can be obtained based on the provided drawings without creative efforts.

FIG. 1 shows a schematic structural diagram of an example detection unit array.

FIG. 2 shows a schematic diagram of circuit connection of an example detector array, consistent with some embodiments of this disclosure.

FIG. 3 shows a schematic structural diagram of an example detection unit including multiple SPADs, consistent with some embodiments of this disclosure.

FIG. 4 shows a schematic diagram of pads of the detector array of FIG. 2.

FIG. 5 shows a schematic diagram of an example arrangement of detection units in the detector array of FIG. 2.

FIG. 6 shows a schematic structural diagram of an example light receiver, consistent with some embodiments of this disclosure.

FIG. 7 shows a structural schematic diagram of another example light receiver, consistent with some embodiments of this disclosure.

FIG. 8 shows a schematic diagram of an example connection structure of a detector array in the light receiver of FIG. 7.

FIG. 9 shows a schematic diagram of another example connection structure of the detector array in the light receiver of FIG. 7.

FIG. 10 shows a flow chart of an example method of controlling a detector array, consistent with some embodiments of this disclosure.

### DETAILED DESCRIPTION

To make the above objects, features and beneficial effects of the present disclosure more obvious and understandable, example embodiments of the present disclosure are described below with reference to the accompanying drawings.

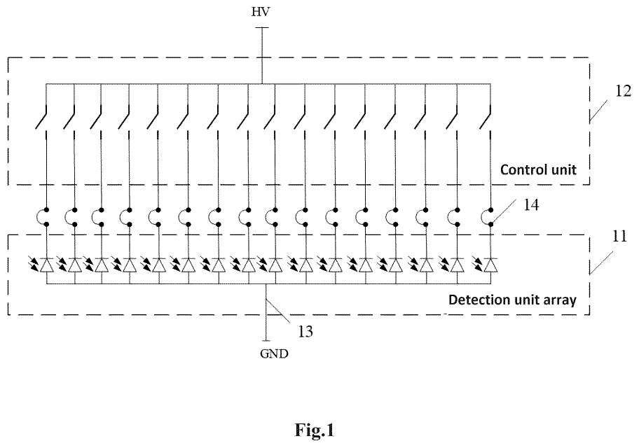

FIG. 1 shows a schematic structural diagram of an example detection unit array. As shown in FIG. 1, the detection unit array 11 has a common anode. For example, the detection unit array 11 shares an anode bus 13. To achieve the purpose of individually gating each detector, a cathode gating method can be adopted. Therefore, the cathode of each detection unit needs to be connected separately, and the cathode of each detection unit needs to be connected to the control unit 12 with a separate metal wire. For example, the cathode of each detection unit of the detection unit array 11 needs to be separately connected to a pad 14. In the existing PCB wiring process, it can be difficult to reduce the spacing between two adjacent pads 14 to less than 300 μm due to various factors (e.g., a width of the metal wire, a minimal line spacing between the metal wires, a size of the pads, or the like). As a result, when the number of lines of LiDAR increases, the number of detection units increases. The spacing between detection units needs to be increased to have enough wiring space. Such a structure is not advantaged to improve the resolution of the LiDAR.

To address the above problems, embodiments of the present disclosure provide a detector array that groups multiple detection units by arranging a certain number of anode buses and cathode buses. Each detection unit can adopt a different connection manner (e.g., the detection units connected to the same anode bus can be connected to different cathode buses, and the detection units connected to the same cathode bus can be connected to different anode buses). The cathode and anode bidirectional gating can be used to determine the gated detection unit (e.g., by selecting an anode bus and a cathode bus, the only detection unit to be gated can be determined). Because the interconnected detection units (e.g., detection units connected to the same anode bus, or detection units connected to the same cathode bus) share the same driving, the number of driving channels and the number of pads can be greatly reduced. While ensuring the performance of the detection unit, the detection units can be arranged more densely, thereby improving the resolution of the LiDAR.

In some embodiments, the detector array provided by the embodiment of the present disclosure can include N detection-unit groups, each detection-unit group including M detection units. The detector array can include: a plurality of detection-unit groups, each of the detection-unit groups including a plurality of detection units. The detector array can also include a plurality of anode buses, each of the anode buses connecting the plurality of detection units in the same detection-unit group. The detector array can further include a number of the anode buses corresponding to a number of the detection-unit group. The detector array can further include a plurality of cathode buses, each of the cathode buses connecting the detection units in at least two of the detection-unit groups, and the plurality of detection units in the same detection-unit group being connected to different cathode buses, respectively.

The detection unit can receive an optical signal when the anode bus and cathode bus connected to the detection unit are simultaneously gated. The detection unit can convert the optical signal into an electrical signal for output. In some embodiments, the detector can receive an optical signal and generate an electrical signal in an activated state. The activated state of the detector represents that the detector is under a reverse bias voltage, and the magnitude of the reverse bias voltage reaches its operating voltage.

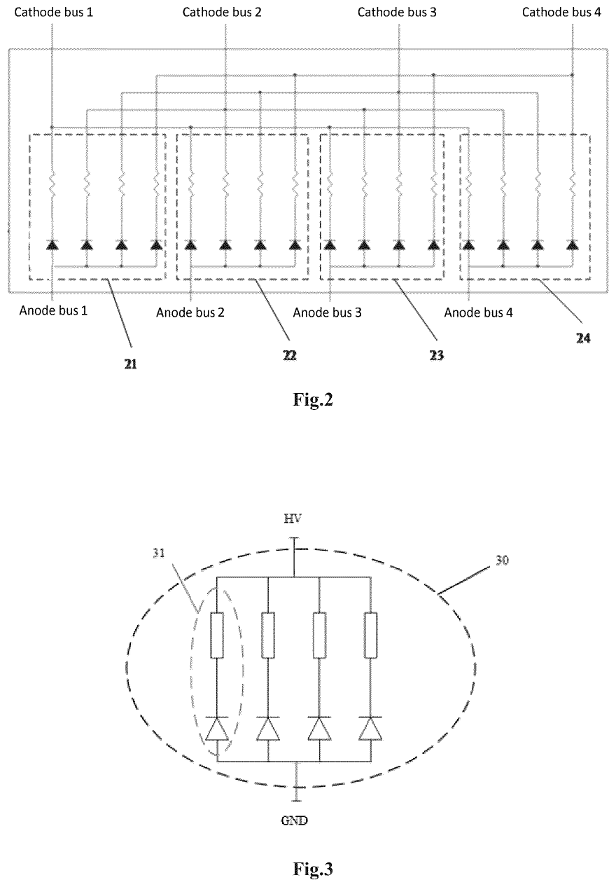

FIG. 2 shows a schematic diagram of circuit connection of an example detector array, consistent with some embodiments of this disclosure. As shown in FIG. 2, the detector array includes four detection-unit groups (e.g., each detection-unit group being represented by a dotted box in FIG. 2). The four detection-unit groups are a first detection-unit group 21, a second detection-unit group 22, a third detection-unit group 23, and a fourth detection-unit group 24. In addition, four anode buses (e.g., anode buses 1 through 4) and four cathode buses (e.g., cathode buses 1 through 4) are provided.

With reference to FIG. 2, each detection-unit group (i.e., detection-unit group 21 through 24) includes four detection units. Anodes of the four detection units in the same group are connected to the same anode bus. For example, as shown in FIG. 2, the anodes of the four detection units of the first detection-unit group 21 are connected to the anode bus 1. The anodes of the four detection units of the second detection-unit group 22 are connected to the anode bus 2. The anodes of the four detection units of the third detection-unit group 23 are connected to the anode bus 3. The anodes of the four detection units of the fourth detection-unit group 24 are connected to the anode bus 4.

Continuing with reference to FIG. 2, for case of description, the detection units in each group are referred to as the first detection unit, the second detection unit, the third detection unit, and the fourth detection unit from left to right, respectively. The cathodes of the detection units in each detection-unit group can be connected to different cathode buses, respectively. For example, in the first detection-unit group 21, the cathode of the first detection unit is connected to the cathode bus 1. The second detection unit is connected to the cathode bus 2. The third detection unit is connected to the cathode bus 3. The fourth detection unit is connected to the cathode bus 4. Similarly, the cathodes of detection units in the other three detection-unit groups are connected in the same manner as cathodes of the corresponding detection units in the first detection-unit group 21, as shown in FIG. 2. It should be noted that the arrangement order of the detection units in each group cannot be limited to the above-described order (e.g., from left to right), and can use other arrangements, which is not limited in embodiments of the present disclosure.

As shown in FIG. 2, for example, the number of detection-unit groups and the number of detection units in each group can be the same. In some embodiments, the number of detection-unit groups and the number of detection units in each group can be different, which is not limited in embodiments of the present disclosure.

For example, the detector array can include five detection-unit groups, and each detection-unit group can include four detection units. In such a case, five anode buses and four cathode buses can be used.

As another example, the detector array can include four detection-unit groups, and each detection-unit group can include five detection units. In such a case, four anode buses and five cathode buses can be used.

In addition, in some embodiments, the number of detection units in each detection-unit group can be the same or different, which is not limited in the example shown in FIG. 2 or other embodiments of the present disclosure.

For example, the detector array can include five detection-unit groups, where each of the first group, the second group, and the third group can include four detection units, and each of the fourth group and the fifth group can include three detection units. For example, the first group to the third group can each include a first detection unit, a second detection unit, a third detection unit, and a fourth detection unit. The fourth group and the fifth group can each include a first detection unit, a second detection unit, and a third detection unit. In such a case, the number of anode buses can be five, and each anode bus can be connected to all detection units in a group. The number of cathode buses can be four, where the cathode bus 1 can be connected to the first detection units in the first through fifth groups. The cathode bus 2 can be connected to the second detection units in the first through fifth groups. The cathode bus 3 can be connected to the third detection units in the first through fifth groups. The cathode bus 4 can be connected to the fourth detection units in the first through third groups.

Consistent with embodiments of this disclosure, the detection unit in the embodiment of the present disclosure can include a single photon detector. Each detection unit can correspond to a pixel (e.g., a pixel in a point cloud). A single photon detector can detect a single photon and detect signals with low energy intensity, and therefore have better signal detection capabilities.

In some embodiments, each detection unit of the detector array can include one or more detectors. For example, and the detector can be a silicon photomultiplier (“SiPM”) or a single photon avalanche diode (“SPAD”). For example, each detection unit can include a SiPM or multiple SPADs. In some embodiments, for the detection unit using SiPM, each detection unit can include a SiPM detector. The electrical signal converted by the photons received by the SiPM can be an analog signal. The magnitude of the analog signal can reflect the amount of light energy received by the SiPM. In some embodiments, for a detection unit using SPAD, each detection unit can include multiple SPADs. The electrical signal output by each detection unit after receiving photons can be a digital signal. For example, the SPAD detector can generate a signal after receiving photons, and the number of SPAD detectors that output electrical signals can be recorded. The number of generated electrical signals can reflect the amount of light energy received by the detection unit.

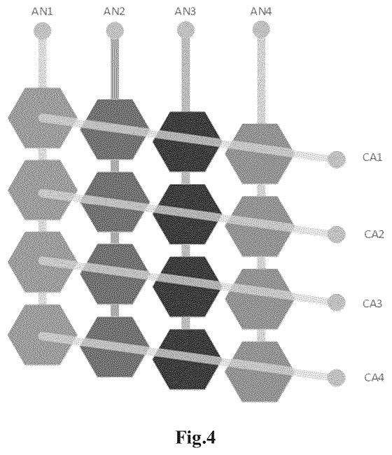

FIG. 3 shows a schematic structural diagram of an example detection unit including multiple SPADs, consistent with some embodiments of this disclosure. In FIG. 3, each detection unit 30 includes four SPADs 31. The SPADs 31 in each detection unit 30 are connected in parallel.

It should be noted that different detection units in the above-described detection unit array can use the same or different devices, which is not limited by the embodiments of the present disclosure.

In some embodiments, the detection unit can include a back-side-illumination (“BSI”) detection unit or a front-side-illumination (“FSI”) detection unit, which is not limited in the embodiments of the present disclosure.

In some embodiments, in a manufacturing process of a detector array, the anodes of the detection units that share an anode bus can be connected, and the cathodes of the detection units that share a cathode bus can be connected. The cathode and anode of different detection units can be connected to the corresponding cathode bus and anode bus. The connection can be implemented by a metal layer on the silicon wafer or by wirings (e.g., by connecting the two terminals supposed to be connected to a printed circuit board (“PCB”) and then connecting them through the wirings on the PCB). It should be noted that other connection methods can also be used, and they are not limited to connecting through the wirings on the PCB.

In some embodiments, as for an FSI detection unit array, all detection units on a wafer can share a common anode, and the cathode of each detector can be separated. Therefore, the detection units sharing a common anode can be made on one wafer, and then the detection units sharing a common cathode on different wafers can be connected together through wirings. As for a BSI detection unit array, the anode and cathode of each detection unit can be separated. Therefore, all detection units can be implemented on one wafer. For example, by designing the structure of the wafer, some detection units can share an anode, and some detectors can share a cathode. Alternatively, similar to the FSI detection unit, the detection units in the detection unit array can be distributed to several wafers, and then the detection units that share a common anode or a common cathode can be connected through wirings.

Compared with detection units arranged on multiple wafers, the detection unit array arranged on the same wafer can be arranged more densely. For this reason, the detector array provided by the embodiment of the present disclosure can be arranged preferably in the BSI mode.

Consistent with embodiments of this disclosure, the detector array provided by the embodiment of the present disclosure can divide the anodes of multiple detection units into groups through grouping and corresponding connection manner. The anodes of multiple detection units in the same group can be connected to the same anode bus, and the multiple detection units in the same group can be connected to different cathode buses. Because the interconnected detection units can share the same driving, the number of driving channels and the number of wirings or pads can be greatly reduced, thus enabling the detection units to be arranged more densely. More detection units can be accommodated in the same space while maintaining a certain line spacing and ensuring the performance of the detection unit, which also means that the LiDAR can have more lines to meet the application requirements of higher resolution.

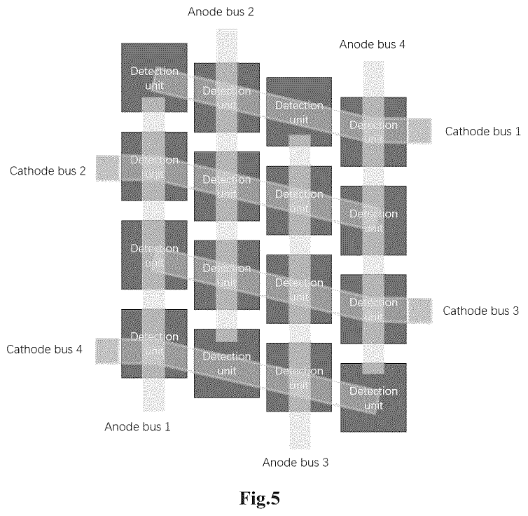

Referring back to FIG. 2, as an example, the anodes of the four detection units in the same detection-unit group can be interconnected. FIG. 4 shows a schematic diagram of pads of the detector array of FIG. 2. As shown in FIG. 4, the cathodes of the four detection units can be interconnected. Compared with an existing technique that requires 16 driving channels and 16 pads, the detection unit array of FIG. 2 only needs 8 pads. For example, as shown in FIG. 4, the 8 pads include four pads (represented as AN1, AN2, AN3, and AN4 in FIG. 4) that are connected to each anode bus, respectively, and four pads (represented as CA1, CA2, CA3, and CA4 in FIG. 4) that are connected to each cathode bus, respectively. By doing so, the number of pads can be greatly reduced, and the detection units can be arranged more densely.

For the detector array provided by embodiments of this disclosure, a readout circuit can be connected to the detection unit through a cathode bus or an anode bus. Compared with the existing technique where one cathode bus is connected to one detection unit, multiple detection units can share a cathode bus, consistent with embodiments of this disclosure. In the case where the gain of the readout circuit is not adjusted, if there are too many detection units sharing the same cathode bus, it can affect the amplitude of the output signal of the readout circuit, thereby affecting the accuracy of the readout data. For example, the arrival time of the detection beam can be calculated from the time when an electrical signal generated by the detection unit exceeds the threshold. The time of flight of the detection beam can then be determined, and the distance from an object can be calculated. When there are too many detection units sharing the same cathode bus, the amplitude of signal output by the readout circuit can decrease, resulting that the time when the electrical signal generated by the detection unit exceeds the threshold is delayed, causing the calculated distance from the object to be inaccurate. For this reason, in some embodiments of this disclosure, the number of detection units sharing a cathode bus can be limited to not exceed a value. For example, the value can be lower than or equal to 8. By limiting the number of detection units sharing a cathode bus to not exceed a value, the reduction in the amplitude of signal output by the readout circuit can be reduced or prevented from affecting detection accuracy.

Consistent with some embodiments of this disclosure, the detector array can include multiple detection units. In an example structural design, the detection units can be arranged uniformly or non-uniformly. In some embodiments, the arrangement directions of the detection units in the detector array can include two directions in a two-dimension plane, such as a first arrangement direction (e.g., a horizontal direction or a vertical direction) and a second arrangement direction (e.g., the vertical direction or the horizontal direction). Any two detection units in the detector array can be arranged staggered from each other in the first arrangement direction, for example.

Referring back to FIG. 2, as an example, an arrangement structure of 16 detection units of FIG. 2 can be shown in FIG. 5. FIG. 5 shows a schematic diagram of an example arrangement of detection units in the detector array of FIG. 2. Each square in FIG. 5 represents a detection unit. Each strip in FIG. 5 represents a bus, where a horizontal strip represents a cathode bus, and a vertical strip represents an anode bus. In FIG. 5, the four detection units in each detection-unit group can be arranged one after another in the vertical direction, so there are four columns in total. The four columns of detection units can be staggered from each other in the vertical direction. For example, with the vertical direction as the first direction, each detection unit in the detector array can be located at a different height in the vertical direction. As shown in FIG. 5, the four columns of detection units are positioned downwards in sequence. For example, each column is positioned downwards by a distance with respect to its left column. In this way, the vertical field-of-view (“FOV”) angles of the LiDAR corresponding to the four detection units in each detection-unit group can be different. By doing so, the number of sampling points obtained in a single measurement can be increased, and the resolution of the LiDAR in the vertical direction can be improved. The distance between two detection units (e.g., the first detection unit in the first column counted from the left and the first detection unit in the second column counted from the left in FIG. 5) of adjacent heights can be very small in the vertical direction (e.g., the first direction). Thus, the angular resolution of the LiDAR in the vertical direction can be very small, and two objects that are closely spaced can be distinguished, which can be beneficial to improving detection performance. Similarly, a similar arrangement can be adopted in the horizontal direction, which can improve the resolution of the LiDAR in the horizontal direction.

Consistent with embodiments of this disclosure, embodiments of the present disclosure also provide a chip, which includes the above-described detector array.

Embodiments of the present disclosure also provide a light receiver or a light receiver module, which includes a control unit and a detector array. Reference can be made to the descriptions in the above embodiments for the detector array.

In some embodiments, control unit of the light receiver can include a plurality of anode driving circuits. The light receiver can also include a plurality of cathode driving circuits. The light receiver can further include an anode data multiplexer and a cathode data multiplexer. Depending on the number of detection-unit groups in the detector array and the number of detection units included in each group, the number of the anode driving circuits and the cathode driving circuits can vary. Assuming that the detector array includes N detection-unit groups, and each detection-unit group includes M detection units, then the control unit can include N anode driving circuits and M cathode driving circuits Each of the N anode driving circuits can be connected to the anode data multiplexer and one of the anode buses. Each of the M cathode driving circuits can be connected to the cathode data multiplexer and one of the cathode buses. The anode data multiplexer can be used to gate the anode driving circuit based on the first trigger signal. The cathode data multiplexer can be used to gate the cathode driving circuit based on the second trigger signal.

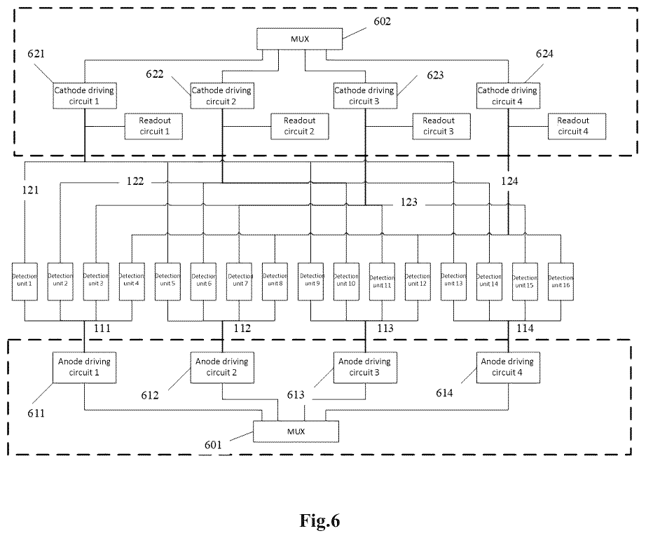

FIG. 6 shows a schematic structural diagram of an example light receiver, consistent with some embodiments of this disclosure. For example, the detector array in the light receiver of FIG. 6 can be the detector array of FIG. 2. In some embodiments, the control unit of the detector array can be illustrated as the circuits within the two dotted boxes shown in FIG. 6, including four anode driving circuits 611, 612, 613, and 614, and four cathode driving circuits 621, 622, 623, and 624.

As shown in FIG. 6, each of the anode driving circuits 611, 612, 613, and 614 is connected to the anode data multiplexer 601 and an anode bus. In FIG. 6, the anode driving circuit 611 is connected to an anode bus 111. The anode driving circuit 612 is connected to an anode bus 112. The anode driving circuit 613 is connected to an anode bus 113. The anode driving circuit 614 is connected to an anode bus 114.

As shown in FIG. 6, each of the cathode driving circuits 621, 622, 623, and 624 is connected to the cathode data multiplexer 602 and a cathode bus. In FIG. 6, the cathode driving circuit 621 is connected to a cathode bus 121. The cathode driving circuit 622 is connected to a cathode bus 122. The cathode driving circuit 623 is connected to a cathode bus 123. The cathode driving circuit 623 is connected to a cathode bus 124.

In some embodiments, the number of anode driving circuits in the control unit can exceed the number of anode buses. For example, two or more anode driving circuits can be arranged to connect to the same anode bus. In such a scenario, if any anode driving circuit is gated, the anode bus can be gated. Similarly, in some embodiments, the number of cathode driving circuits in the control unit exceeds the number of cathode buses. For example, two or more cathode driving circuits can be arranged to connect to the same cathode bus. In such a scenario, if any cathode driving circuit is gated, the cathode bus can be gated.

In some embodiments, as shown in FIG. 6, the light receiver can further include a readout circuit (e.g., readout circuits 1, 2, 3, or 4) that can collect the electrical signal output by the detection units. As an example, each readout circuit can be connected to a cathode bus.

In FIG. 6, each cathode bus can be connected to a readout circuit. The anode data multiplexer 601 can gate the anode driving circuit based on the first trigger signal. The cathode data multiplexer 602 can gate the cathode driving circuit based on the second trigger signal. The gated anode driving circuit can be switched on to form a pathway. By doing so, the anode bus connected to the pathway can be switched on and connected to the ground or negative high voltage. The gated cathode driving circuit can be switched on to form a pathway. By doing so, the cathode bus connected to the pathway can be switched on and connected to the positive high voltage or ground (e.g., corresponding to the anode bus being grounded). It should be noted that, the first trigger signal can gate one anode driving circuit at a time, and the second trigger signal can gate at least one cathode driving circuit at a time. By doing so, only one of multiple detection units connected to the same readout circuit can be gated during operation to prevent the readout circuit from being unable to distinguish which detection unit outputs the signal. The detection units with their corresponding anode driving circuit and cathode driving circuit simultaneously gated can be activated. When an activated detection unit receives photons, the activated detection unit can convert the optical signal (e.g., generated from the received photons) into an electrical signal and output it to the readout circuit.

It should be noted that, depending on the device used and the control manner of the detection unit, each cathode bus can be connected to one of the readout circuits. Alternatively, each anode bus can be connected to a readout circuit. The connection schemes are not limited in embodiments of the disclosure. The embodiments described in association with FIG. 6 illustrate a case where each readout circuit is connected to a cathode bus.

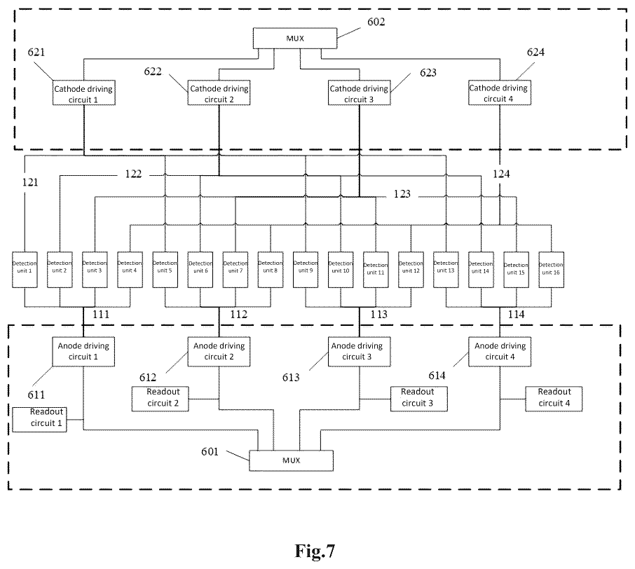

FIG. 7 shows a structural schematic diagram of another example light receiver, consistent with some embodiments of this disclosure. Compared with FIG. 6, in FIG. 7, each anode bus is connected to one of the readout circuits. The first trigger signal can gate at least one anode driving circuit at a time, and the second trigger signal can gate a cathode driving circuit at a time. By doing so, only one of multiple detection units connected to one readout circuit can be gated during operation to prevent the readout circuit from being unable to distinguish which detection unit outputs the signal. The detection units with their corresponding anode driving circuit and cathode driving circuit simultaneously gated can be activated. When an activated detection unit receives photons, the activated detection unit can convert the optical signal (e.g., generated from the received photons) into an electrical signal and output it to the readout circuit.

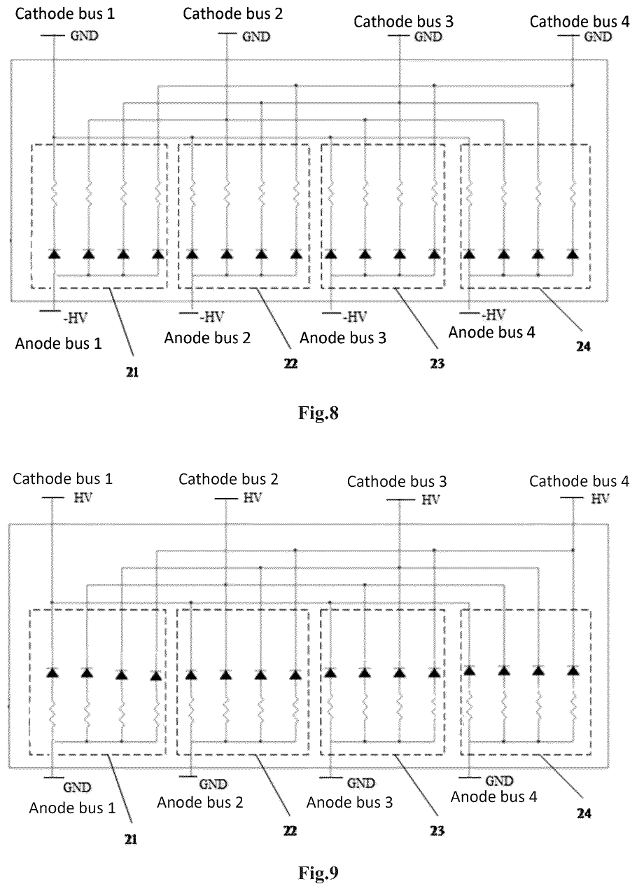

In some embodiments, the anode bus and the cathode bus can be connected in two modes, as shown in FIG. 8 and FIG. 9. FIG. 8 shows a schematic diagram of an example connection structure of a detector array in the light receiver of FIG. 7. In FIG. 8, each cathode bus is connected to a ground GND. The anode bus is connected to a negative high voltage-HV. FIG. 9 shows a schematic diagram of another example connection structure of the detector array in the light receiver of FIG. 7. In FIG. 9, each cathode bus is connected to a positive high voltage HV. The anode bus is connected to a ground GND. Consistent with embodiments of this disclosure, the connection modes described in association with FIG. 8 or FIG. 9, can ensure that the detection unit has a reverse bias voltage and can generate electrical signals in response to photons. By doing so, the echo signal of the transmitted laser can be detected after the transmitted laser being reflected by an object to obtain an arrival time of the echo signal. Then, the distance from the object can be determined by calculating the time of flight of the transmitted laser.

In some embodiments, each detection unit of the detector array can be a BSI detection unit or an FSI detection unit. In some embodiments, each detection unit of the detector array can be the BSI detection unit. In some embodiments, the anode of the BSI detection unit can be a layer of metal on the silicon wafer and can be designed section by section (e.g., a section of the silicon wafer). For example, if the detection unit is a SPAD, multiple pixels (e.g., detection units) can be distributed in each area, and each pixel (e.g., detection unit) can have multiple SPADs inside. If an FSI detection unit is used, all detection units on the same silicon wafer can share a common anode due to structural reasons. Thus, the silicon wafer needs to be divided to obtain multiple detection-unit groups, so that different detection-unit groups do not share an anode. Therefore, in some embodiments, the detection unit array can be implemented in the BSI mode.

In some embodiments, the readout circuit can be connected to at least one detection unit via a cathode bus or an anode bus. In some embodiments, the number of detection units connected to the readout circuit can increase in response to the increase of the gain set by the readout circuit.

In some embodiments, when multiple cathode buses or anode buses are connected in parallel, an amplitude (e.g., a signal amplitude) caused by a single photon can decrease, resulting in inaccuracy of the detection data. For example, compared with the circuit of FIG. 1, in the structure described in association with FIG. 2, 6, or 7, when the cathode bus is connected to the readout circuit, the signal amplitude output by the readout circuit can be lower than the signal amplitude output by the circuit of FIG. 1 under the same light intensity and the same gain of the readout circuit due to many detection units sharing a cathode. When a timestamp of the signal amplitude exceeding the threshold is used to calculate the arrival time of the detection beam and the time of flight, the amplitude of the signal output by the readout circuit can decrease, which can delay the timestamp of the electrical signal of the detection unit exceeding the threshold, resulting in inaccuracy of the calculated distance of the object. Therefore, in the embodiments of the present disclosure, the gain of the readout circuit can be appropriately increased to ensure accuracy of the measurement. For example, the number of detection units connected to the readout circuit can increase in response to the increase of the gain set by the readout circuit. For example, with reference to FIG. 6, simulation results show that, generally, if two detection units share a cathode, the outputted single-photon amplitude can decrease by about 30%. If four detection units share a cathode, the outputted single-photon amplitude can decrease by about 50%. A single-photon amplitude in this disclosure represents a magnitude or amplitude of a signal generated in response to a single photon. For example, the signal can be outputted by a detection unit generated in response to a single photon. A multi-photon amplitude in this disclosure represents a magnitude or amplitude of a signal generated in response to a plurality of photons. For example, the signal can be outputted by a detection unit generated in response to a plurality of photons. In some embodiments, if the single-photon amplitude of a detection unit decreases, the multi-photon amplitude of the detection unit can also decrease. Therefore, when two detection units share a common cathode, the gain of the readout circuit can be increased by 30%. When four detection units share a cathode, the gain of the readout circuit can be increased by 50%. By doing so, accuracy of the measurement can be ensured. Similarly, with reference to FIG. 7, the readout circuit can be connected to the anode bus. Therefore, when two detection units share an anode, the gain of the readout circuit can be increased by 30%. When four detection units share the anode, the gain of the readout circuit can be increased by 50%. By doing so, measurement accuracy can be ensured.

Consistent with embodiments of this disclosure, the present disclosure further provides a LiDAR that includes a laser transmitter or laser transmitting module and a light receiver. In some embodiments, the light receiver can be the light receiver described in association with FIGS. 2 to 9.

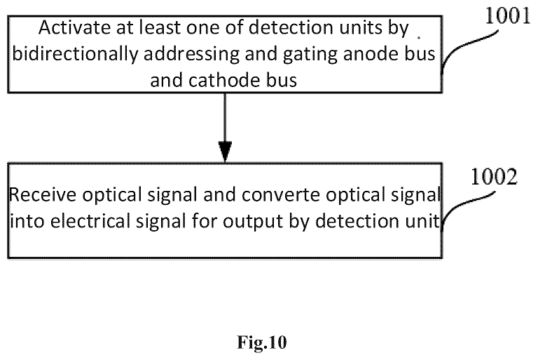

Consistent with embodiments of this disclosure, the present disclosure further provides a method for controlling detection units in a detector array. FIG. 10 shows a flow chart of an example method of controlling a detector array, consistent with some embodiments of this disclosure. As shown in FIG. 10, at step 1001, at least one of the detection units can be activated by bidirectionally addressing and gating the anode bus and the cathode bus.

In some embodiments, the readout circuit can be connected to the cathode bus or the anode bus. When the cathode bus is connected to the readout circuit, an anode bus and at least one cathode bus can be gated each time. Then, the detection unit that is connected to both the gated anode bus and the gated cathode bus can be activated. When the anode bus is connected to the readout circuit, at least one anode bus and a cathode bus can be gated each time. Then, the detection unit that is connected to both the gated anode bus and the gated cathode bus can be activated.

at step 1002, an optical signal can be received, and the optical signal can be converted into an electrical signal for output by the activated detection unit.

In some embodiments, the selected detection unit can be activated by bidirectionally addressing the anode bus and the cathode bus for the detection unit array with the group structure described in association with FIGS. 2 to 9. By doing so, the control of the detection unit can be more flexible and convenient so as to better meet a variety of different application demands.

It should be understood that the term “and/or” in this document is only an association relationship describing related objects, indicating that there can be three relationships. For example, A and/or B can mean three situations including: A alone, both A and B, and B alone. In addition, the character “/” in this document indicates that the related objects are in an “or” relationship. The conjunction “or,” as used herein, refers to a non-exclusive logic OR relationship.

The term “multiple” used in this disclosure refers to two or more.

The terms “first,” “second,” or the like appearing in this disclosure are to distinguish the described objects but do not represent order, sequence, or special limitations on the number of devices.

The term “connection” used in this disclosure refers to various connection methods (e.g., direct connection or indirect connection) to realize communication between devices

Although the present disclosure is disclosed as above, the present disclosure is not limited thereto. Any person skilled in the art can make various changes and modifications without departing from the scope of the claims. Therefore, the protection scope of the present disclosure shall be subject to the scope defined by the claims.

1-16. (canceled)

17. A detector array comprising:
a plurality of detector units, the plurality of detector units being divided into a plurality of detector unit groups;
a plurality of anode buses, each anode bus of the plurality of anode buses connecting a plurality of detector units in a same detector unit group, and a number of the anode buses corresponding to a number of the detector unit groups;
a plurality of cathode buses, each cathode bus of the plurality of cathode buses connecting a plurality of detector units in at least two detector unit groups of the plurality of detector unit groups, and the plurality of detector units in the same detector unit group being connected to different cathode buses; and
a detector unit of the plurality of detector units is configured to receive an optical signal when an anode bus and a cathode bus both connected to the detector unit are gated, and convert the optical signal into an electrical signal for output.

18. The detector array of claim 17, wherein the detector unit is a single photon detector, and each detector unit of the plurality of detector units corresponds to a pixel.

19. The detector array of claim 18, wherein the detector unit comprises a detector, and the detector is a silicon photomultiplier or a single-photon avalanche diode.

20. The detector array of claim 17, wherein the detector unit is a back-side-illumination detector or a front-side-illumination detector.

21. The detector array of any of claim 17, wherein a plurality of detector units sharing one anode bus or one cathode bus are connected by wirings or by a metal layer on a silicon wafer.

22. The detector array of claim 21, wherein the number of detector units sharing one cathode bus is less than or equal to 8.

23. The detector array of claim 17, further comprising a first arrangement direction and a second arrangement direction, wherein any two detector units in the detector array are arranged staggered from each other in the first arrangement direction.

24. A chip, comprising a detector array, the detector array comprising:
a plurality of detector units, the plurality of detector units being divided into a plurality of detector unit groups;
a plurality of anode buses, each anode bus of the plurality of anode buses connecting a plurality of detector units in a same detector unit group, and a number of the anode buses corresponding to a number of the detector unit groups;
a plurality of cathode buses, each cathode bus of the plurality of cathode buses connecting a plurality of detector units in at least two detector unit groups of the plurality of detector unit groups, and the plurality of detector units in the same detector unit group being connected to different cathode buses; and
a detector unit of the plurality of detector units is configured to receive an optical signal when an anode bus and a cathode bus both connected to the detector unit are gated, and convert the optical signal into an electrical signal for output.

25. A light receiver, comprising:
a control unit comprising a plurality of anode driving circuits, a plurality of cathode driving circuits, an anode data multiplexer, and a cathode data multiplexer; and
a detector array comprising:
a plurality of detector units, the plurality of detector units being divided into a plurality of detector unit groups;
a plurality of anode buses, each anode bus of plurality of the anode buses connecting a plurality of detector units in a same detector unit group, and a number of the anode buses corresponding to a number of the detector unit groups; and
a plurality of cathode buses, each cathode bus of the plurality of cathode buses connecting a plurality of detector units in at least two detector unit groups of the plurality of detector unit groups, and the plurality of detector units in the same detector unit group being connected to different cathode buses; and
a detector unit of the plurality of detector units is configured to receive an optical signal when an anode bus and a cathode bus both connected to the detector units are gated, and convert the optical signal into an electrical signal for output;
wherein each anode driving circuit of the plurality of anode driving circuits is connected to the anode data multiplexer and one anode bus of the plurality of anode buses, and each cathode driving circuit of the plurality of cathode driving circuits is connected to the cathode data multiplexer and one cathode bus of the plurality of cathode buses, and
wherein the anode data multiplexer is configured to gate an anode driving circuit of the plurality of anode driving circuits based on a first trigger signal, and the cathode data multiplexer is configured to gate a cathode driving circuit of the plurality of cathode driving circuits based on a second trigger signal.

26. The light receiver of claim 25, further comprising:
readout circuits configured to collect an electrical signal output by the detection unit,
wherein each cathode bus of the plurality of cathode buses is connected to a readout circuit of the readout circuits; or each anode bus of the plurality of anode buses is connected to a readout circuit of the readout circuits.

27. The light receiver of claim 26, wherein each cathode bus of the plurality of cathode buses is connected to a readout circuit of the readout circuits, the first trigger signal gates one of the anode driving circuits at a time, and the second trigger signal gates at least one of the cathode driving circuits at a time.

28. The light receiver of claim 26, wherein each anode bus of the plurality of anode buses is connected to a readout circuit of the readout circuits, the first trigger signal gates at least one of the anode driving circuits at a time, and the second trigger signal gates one of the cathode driving circuits at a time.

29. The light receiver of claim 26, wherein the readout circuit is connected to at least one of the plurality of detection units via a cathode bus of the plurality of cathode buses or an anode bus of the plurality of anode buses, and a gain set by the readout circuit is configured to increase corresponding to an increase of a number of the detection unit connected to the readout circuit.

30. A LiDAR comprising a laser transmitter and a light receiver, the light receiver comprising:
a control unit comprising a plurality of anode driving circuits, a plurality of cathode driving circuits, an anode data multiplexer, and a cathode data multiplexer; and
a detector array comprising:
a plurality of detector units, the plurality of detector units being divided into a plurality of detector unit groups;
a plurality of anode buses, each anode bus of plurality of the anode buses connecting a plurality of detector units in a same detector unit group, and a number of the anode buses corresponding to a number of the detector unit groups;
a plurality of cathode buses, each cathode bus of the plurality of cathode buses connecting a plurality of detector units in at least two detector unit groups of the plurality of detector unit groups, and the plurality of detector units in the same detector unit group being connected to different cathode buses; and
a detector unit of the plurality of detector units is configured to receive an optical signal when an anode bus and a cathode bus both connected to the detector units are gated, and convert the optical signal into an electrical signal for output;
wherein each anode driving circuit of the plurality of anode driving circuits is connected to the anode data multiplexer and one anode bus of the plurality of anode buses, and each cathode driving circuit of the plurality of cathode driving circuits is connected to the cathode data multiplexer and one cathode bus of the plurality of cathode buses, and
wherein the anode data multiplexer is configured to gate an anode driving circuit of the plurality of anode driving circuits based on a first trigger signal, and the cathode data multiplexer is configured to gate a cathode driving circuit of the plurality of cathode driving circuits based on a second trigger signal.

31. A method of controlling detection units in a detector array, wherein the detector array comprises a plurality of detector units, the plurality of detector units being divided into a plurality of detector unit groups; a plurality of anode buses, each anode bus of the plurality of anode buses connecting a plurality of detector units in a same detector unit group, and a number of the anode buses corresponding to a number of the detector unit groups; a plurality of cathode buses, each cathode bus of the plurality of cathode buses connecting a plurality of detector units in at least two detector unit groups of the plurality of detector unit groups, and the plurality of detector units in the same detector unit group being connected to different cathode buses; and a detector unit of the plurality of detector units is configured to receive an optical signal when an anode bus and a cathode bus both connected to the detector unit are gated, and convert the optical signal into an electrical signal for output, the method comprising:
activating at least one of the plurality of detector units by addressing and gating an anode bus and a cathode bus; and
receiving an optical signal and converting the optical signal into an electrical signal for output by the activated detector unit.

32. The method of claim 31, wherein activating the at least one of the plurality of detection units by addressing and gating the anode bus and the cathode bus comprises:
when the cathode bus is connected to a readout circuit, each time one anode bus and at least one cathode bus are gated, activating a detector unit connected to both the gated anode bus and the at least one gated cathode bus; and
when the anode bus is connected to the readout circuit, each time at least one anode bus and one cathode bus are gated, activating a detector unit connected to both the at least one gated anode bus and the gated cathode bus.
